(19) United States
(12) Patent Application Publication
(10) Pub. No.: US 2004/0064309 A1
(43) Pub. Date: Apr. 1, 2004

(54) Mobile communicator and method for deciding speech coding rate in mobile communicator

(75) Inventor: Atsushi Kosai, Tokyo (JP)

Correspondence Address: ROTHWELL, FIGG, ERNST & MANBECK, P.C., 1425 K STREET, N.W., SUITE 800, WASHINGTON, DC, 20005, US

(73) Assignee: Mitsubishi Denki Kabushiki Kaisha, Tokyo (JP)

(21) Appl. No.: 10/671,391

(22) Filed: Sep. 26, 2003

Related U.S. Application Data
(63) Continuation of application No. 09/488,022, filed on Jan. 20, 2000, now abandoned.

(30) Foreign Application Priority Data
Feb. 18, 1999 (JP) HEI 11-039441

(51) Int. Cl. G10L 19/14

(52) U.S. Cl. 704/211

(57) ABSTRACT

This invention relates to a mobile communicator which is arranged to save power by efficiently controlling a power amplifier by selecting an adequate speech coding rate. An inventive mobile communicator comprises a plurality of encoding means for encoding a speech signal with different encoding rates, respectively; encoding rate inputting means for accepting an input of encoding rate selected by a terminal user; and encoding rate deciding means for deciding an encoding rate applied for encoding the speech signal based on the encoding rate inputted via the encoding rate inputting means and for selectively switching the plurality of encoding means corresponding to this encoding rate.

### BACKGROUND OF THE INVENTION

1. Field of the Invention

The present invention relates to a mobile communicator which is arranged to save power by efficiently controlling a power amplifier by selecting an adequate speech coding rate.

2. Description of the Related Art

FIG. 10 is a block diagram showing the structure of a mobile communicator having prior art speech coding rate control means. FIG. 11 is a block diagram showing the structure of a speech codec in the mobile communicator of FIG. 10. In the mobile communicator 601 in a communication system conforming to IS-95 Standard, speech analog data of a user inputted from a microphone 602 is amplified by a voltage amplifier 603 and is then converted into speech digital data by an AD converter 604. This speech digital data is inputted to a speech encoder 630 (hereinafter referred to as a speech CODEC) to be encoded in the format of CELP (Code Excited Linear Predictive). The speech encoding technology is a technology of reducing a number of bits in the digital bits representing a speech signal by removing redundancy contained in the speech signal and by utilizing the human hearing characteristics. It is important from the aspects of effectively utilizing frequency and of compressing an information amount.

The speech digital data encoded in the CELP format in the speech CODEC is outputted in a mode of a Tx voice packet 611. The encoding in the CELP format is executed by a DC cutting part 631, an autocorrection function calculator 632, a linear predictor coefficient calculator 633, a LSP (Line Spectrum Pair) calculator 635 and any one of encoders of an Rate 1 encoder 638, an Rate 1/2 encoder 639, an Rate 1/4 encoder 640 and an Rate 1/8 encoder 641 which implement the encoding process corresponding to the encoding rate. Although the lower the encoding rate, the smaller the transmission amount and the lower the speech quality become, it allows the frequency to be utilized effectively.

In IS-95 Standard, the mobile communicator 601 can transmit a Tx data packet 610 such as FAX data, a call processing signaling packet 608 for informing a response, a request or status information to a base station system and others on one reverse traffic channel. It can also transmit only the Tx voice packet 611, only the call processing signaling packet 608, only the Tx data packet 610, a combination of the Tx voice packet 611 and the call processing signaling packet 608, a combination of the Tx voice packet 611 and the Tx data packet 610 or a combination of the call processing signaling packet 608 and the Tx data packet 610 on one reverse traffic channel.

The Tx data packet 610 is generated by the data processor 609 and the call processing signaling packet 608 is generated by the call processing processor 606. During the transmission, the Tx voice packet 611, the call processing signaling packet 608 and the Tx data packet 610 are inputted to a reverse traffic channel encoder 612. The reverse traffic channel encoder 612 multiplexes the various packets by a time-division multiplexing method to output to a reverse traffic channel transmitter 613.

The reverse traffic channel encoder 612 also grasps the transmission rate of the reverse traffic channel, i.e., the encoding rate applied to the encoding process, and outputs a power amplifier ON/OFF control signal 616 to a power amplifier 614 corresponding to this encoding rate. Based on the power amplifier ON/OFF control signal 616 outputted from the reverse traffic channel encoder 612, the power amplifier 614 amplifies the output of the transmission signal and outputs it to an antenna 615. Because the power amplifier 614 amplifies the output of the transmission signal, it is a circuit whose power consumption is specifically large in the mobile communicator.

In transmitting a speech signal encoded with the encoding rate 1, the reverse traffic channel encoder 612 outputs a power amplifier ON signal to fix the power amplifier 614 in ON state. In transmitting a speech signal encoded with the encoding rate 1/2 (rate 1/4, rate 1/8), the reverse traffic channel encoder 612 outputs a power-amp ON/OFF signal 616 to control ON/OFF of the power amplifier 614 intermittently. That is, as compared to the case encoded by the full-rate, the time during which the power amplifier 614 is turned ON becomes about a half when encoded with Rate 1/2. Accordingly, the power consumption of the power amplifier 614 may be reduced by transmitting the transmission signal encoded with Rate 1/2 more than the transmission signal encoded with Rate 1.

Next, the speech CODEC 630 shown in FIG. 11 used in systems of IS-95, will be explained. According to TIA/EIA/IS-96 Standard, the data format inputted to the speech CODEC is uniform PCM data 605 of source of 104 kbps or more (sampling rate is 8 kHz and the minimum resolution of the AD converter is 13 Kbits or more). The inputted uniform PCM data 605 is encoded into the Tx voice packet 611 per every 20 ms frame in the speech CODEC 630 to be outputted.

The Tx voice packet 611 is encoded into either one format of 8000 kbps (Rate 1), 4000 kbps (Rate 1/2), 2000 kbps (Rate 1/4) or 800 kbps (Rate 1/8). The selection of the encoding rate by the speech CODEC 630 depends on two factors of a value of energy (spectral density) of inputted speech data in unit of frame and an encoding rate control signal inputted from the base station system via the antenna 615.

The encoding rate control signal is a signal for transmitting the encoding rate which has been judged by the base station to be adequate from a communication traffic and the like to each mobile communicator (mobile station). An amount of transmission data to be transmitted by each mobile communicator may be reduced and a capacity of the system may be increased by that, thus meeting to larger communication demands, as each mobile communicator encodes the transmission data with that encoding rate. Accordingly, the encoding rate control signal acts in the direction of lowering the encoding rate decided by each mobile communicator by the spectral density of the speech signal.

Next, a mechanism for deciding the encoding rate by the value of energy of the inputted speech data will be explained. A DC voltage component of the uniform PCM data 605 sampled by 8 kHz (i.e., 160 samples/frame) is deleted by a DC cutting part 631 at first. This signal is cut out next by Hamming window function in the autocorrection function calculator 632. It is then transmitted to a linear predictor coefficient calculator 633 and is formed into the Tx voice packet 611 via a LSP (Line Spectrum Pair) calculator 635 and an encoder corresponding to the encoding rate. The autocorrection function calculator 632 transmits R(0) which is autocorrection function of one sample frequency period to the speech coding rate controller 634 in the same time. The speech coding rate controller 634 compares it with three threshold values lead from an amount of acoustic background noise to decide which encoding rate of Rate 1, Rate 1/2, Rate 1/4 or Rate 1/8 should be used to encode the speech.

Next, a mechanism for deciding the encoding rate by an instruction from the base station will be explained. The base station system can limit the encoding rate applied to the encoding process carried out in the mobile communicator by means of a control signal (field value of RATE_REDUC of three bit length) transmitted by the mobile station on a down traffic channel during the speech. There are the following five patterns in the mode for restricting such encoding rates.

(1) RATE_REDUC=‘000’

When the mobile communicator selects Rate 1 as the encoding rate of speech inputted from the microphone in the built-in speech CODEC, it may transmit on the reverse traffic channel as it is.

(2) RATE_REDUC=‘001’

When the mobile communicator selects Rate 1 consecutively in three frames and selects Rate 1 in the fourth frame as the encoding rate of speech inputted from the microphone in the built-in speech CODEC, it must transmit by dropping the encoding rate of the fourth frame to Rate 1/2.

(3) RATE_REDUC=‘010’

When the mobile communicator selects Rate 1 and selects Rate 1 in the next frame as the encoding rate of speech inputted from the microphone in the built-in speech CODEC, it must transmit by dropping the encoding rate of the second frame to Rate 1/2.

(4) RATE_REDUC=‘011’

When the mobile communicator selects Rate 1 and selects Rate 1 consecutively in the next three frames as the encoding rate of speech inputted from the microphone in the built-in speech CODEC, it must transmit by dropping the encoding rate of the second and the following frames to Rate 1/2.

(5) RATE_REDUC=‘100’

When the mobile communicator selects Rate 1 as the encoding rate of speech inputted from the microphone in the built-in speech CODEC, it must transmit by dropping the encoding rate to Rate 1/2.

The patterns (1) through (5) described above are defined based on an analytical result that energy of voice generated by human is largest at the starting time of sounding. The call processing processor 606 recognizes the field value of RATE_REDUC and transmits upper limit speech coding rate information corresponding to that value to the speech coding rate controller 634 by the external control signal 607 of the speech coding rate.

The speech coding rate controller 634 selects the lower encoding rate among the encoding rate decided based on R(0) information received from the autocorrection function calculator 632 and the encoding rate specified by the external control signal of speech coding rate 607. A control signal 637 of a speech coding rate selector inputs the transmission speech data to an encoder corresponding to the encoding rate selected by the speech coding rate controller 634 by changing over the switch within a speech coding rate selector 636.

As described above, there are two reasons why the speech coding rate is varied. One reason is to increase the capacity of the mobile communication system to meet with the greater communication demands. That is, it becomes possible to compress an information amount contained in the transmission signals by lowering the encoding rate of the transmission signals transmitted by the mobile communicator and to increase a system capacity by reducing the self-interference of the reverse traffic channel on which a plurality of mobile stations transmit transmission signals.

The second reason is to save power of the mobile communicator. It has been already explained that the power amplifier 614 is a circuit whose power consumption is particularly large among the circuits composing the mobile communicator and that the operating time of the power amplifier 614 differs corresponding to a radio transmission rate (corresponds to the encoding rate) of the mobile communicator. That is, the drop of the encoding rate of the transmission signals transmitted by the mobile communicator allows the operating time of the power amplifier 614 to be reduced, so that it allows the battery operating time of the mobile communicator to be prolonged.

However, in the conventional method for deciding the speech coding rate of the mobile communicator, it has been liable to encode and transmit a speech signal by using a high encoding rate because the encoding rate has been calculated from the energy of human voice regardless whether sound inputted from the microphone 602 is voice of the user or acoustic background noise. The operating time of the power amplifier 614 is prolonged and the power consumption increases when the transmission signal encoded by using the high encoding rate is to be transmitted. Although the power consumption may be saved by reducing the encoding rate, the conventional mobile communicator was not provided with means for reducing the encoding rate corresponding to the intention of the terminal user or the state of the battery, so that practically there was no other way but to depend on the control signal from the base station system to reduce the encoding rate.

The problem which arises as the terminal is not provided with the means for controlling the encoding rate surfaces when a residual amount of the battery of the mobile communicator is exhausted. For instance, the user of the terminal tries to prolong the operating time of the terminal as much as possible in the circumstance in which the battery cannot be charged even though it is almost exhausted, the conventional mobile communicator could not meet with such request because it depended on the control from the base station as for the reduction of the encoding rate and it could not lower the encoding rate on the terminal side.

### SUMMARY OF THE INVENTION

Accordingly, it is a primary object of the invention to solve the above-mentioned problems by providing a mobile communicator which allows the terminal user to arbitrarily select the speech coding rate which has been decided and executed depending on energy of human voice and on the control from the base station in the past.

A secondary object of the invention is to provide a mobile communicator which allows power consumption to be saved and the operating time to be prolonged by efficiently operating a power amplifier by reducing the speech coding rate corresponding to the state of a battery of the mobile communication terminal which has been reduced under the control of the base station in the past.

A tertiary object of the invention is to provide a mobile communicator which allows the terminal user to switch the timing for reducing the speech coding rate which has been dependent on the control of the base station in the past.

An inventive mobile communicator for encoding an inputted speech signal and for amplifying and transmitting the encoded speech signal comprises a plurality of encoding means for encoding the speech signal with different encoding rates, respectively; encoding rate inputting means for accepting an input of encoding rate selected by a terminal user; and encoding rate deciding means for deciding an encoding rate applied for encoding the speech signal based on the encoding rate inputted via the encoding rate inputting means and for selectively switching the plurality of encoding means corresponding to the decided encoding rate.

The inventive mobile communicator may also be provided with encoding rate inputting means having an encoding rate storage section for storing desired encoding rates selected by the terminal user and encoding timing control means for controlling the timing for outputting the encoding rate stored in the encoding rate storage section to the encoding rate deciding means.

The inventive mobile communicator may also be provided with the encoding rate deciding means which is connected with battery monitoring means for monitoring a residual power of the battery and for selecting an encoding rate corresponding to the residual power of the battery.

The inventive mobile communicator may also be provided with the battery monitoring means which is connected with storage means for storing residual power of the battery and encoding rates corresponding to this residual power and which selects the encoding rate by making reference to the storage means.

The inventive mobile communicator may also be provided with the encoding rate deciding means which decides the encoding rate applied to the encoding process based on a first encoding rate selected by the terminal user and inputted via the encoding rate inputting means; a second encoding rate computed from a speech signal inputted via speech signal detecting means for detecting the speech signal generated by the terminal user; a third encoding rate inputted via encoding rate control signal detecting means for detecting an encoding rate control signal informed by a mobile communication network; and a fourth encoding rate selected by the battery monitoring means.

An inventive method for deciding a speech coding rate of a mobile communicator comprising encoding means for encoding an inputted speech signal and amplifying and transmitting the encoded speech signal comprises steps of deciding the encoding rate to be applied to the process for encoding the speech signal based on the encoding rate selected by the terminal user; and selectively switching the plurality of encoding means corresponding to the decided encoding rate.

The inventive method for deciding a speech coding rate of a mobile communicator comprises steps of executing a process of accepting an input of a first encoding rate selected by the user of the mobile communicator as well as a process of computing a fourth encoding rate corresponding to a residual power of a battery; a first process of storing the first encoding rate and the fourth encoding rate; a second process of selecting the lower encoding rate by comparing the first encoding rate and the fourth encoding rate; a third process of selecting the lower encoding rate by comparing a second encoding rate computed corresponding to a speech signal and a third encoding rate informed from a mobile communication network; and a fourth process of selecting the lower encoding rate by comparing the encoding rate selected in the third process and the encoding rate selected in the second process.

The specific nature of the invention, as well as other objects, uses and advantages thereof, will clearly appear from the following description and from the accompanying drawings in which like numerals refer to like parts.

### BRIEF DESCRIPTION OF THE DRAWINGS

FIG. 1 is a block diagram of an inventive mobile communicator having speech coding control means;

FIG. 2 is a block diagram of a speech codec in the inventive mobile communicator of FIG. 1;

FIG. 3 is a block diagram of an upper limit speech coding rate selector and a coding timing controller;

FIG. 4 is a flowchart for explaining a timing controlling process;

FIG. 5 is a block diagram showing the structure of battery monitoring means;

FIG. 6 is a flowchart for explaining an encoding rate selecting process based on a residual level of the battery;

FIG. 7 is a chart for setting the upper limit speech coding rate with respect to a residual level of the battery;

FIG. 8 is a flowchart for explaining an encoding rate controlling process;

FIG. 9 is a flowchart for explaining another encoding rate controlling process; and

FIG. 10 is a block diagram of a mobile communicator having a conventional speech coding rate controller.

FIG. 11 is a block diagram of a speech codec in the mobile communicator of FIG. 10

### DESCRIPTION OF THE PREFERRED EMBODIMENTS

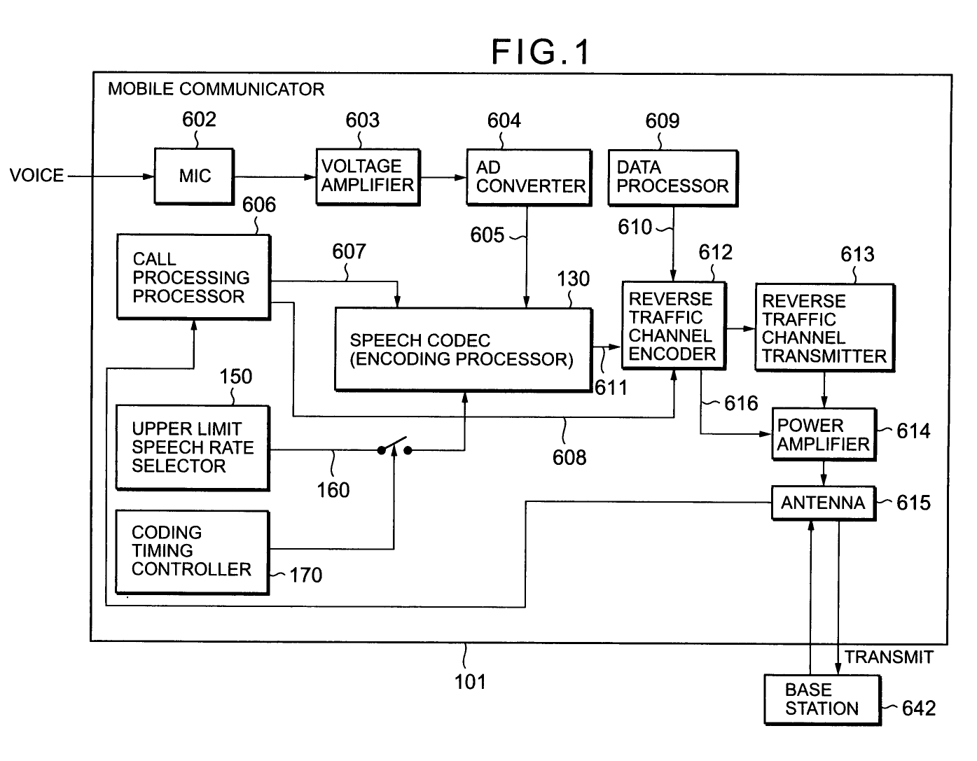

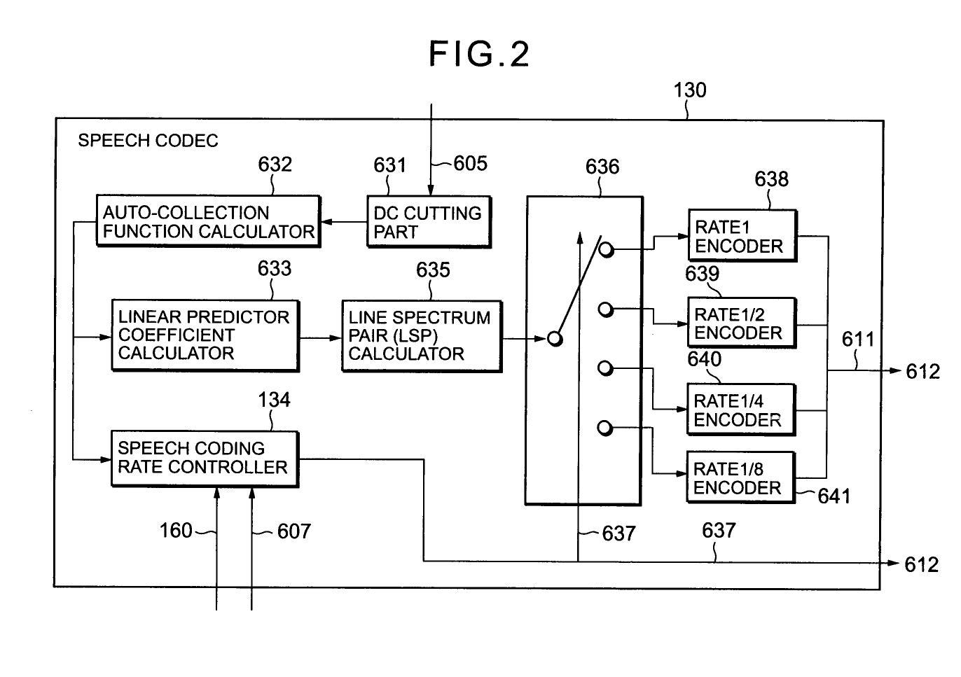

FIG. 1 is a block diagram of an inventive mobile communicator having speech coding control means. FIG. 2 is a block diagram of a speech codec in the inventive mobile communicator of FIG. 1. The inventive mobile communicator 101 comprises an upper limit speech coding rate selector 150 which plays a role of encoding rate inputting means for accepting an input of encoding rate selected by the user of the terminal and has functions of selecting and inputting an upper limit value of the encoding rate and of holding the upper limit value of the selected encoding rate. The reference numeral (160) denotes information of the encoding rate upper limit value selected by the upper limit speech coding rate selector 150 and transmitted to a speech CODEC 130. The reference numeral (170) denotes a coding timing controller for controlling ON/OFF of a path for transmitting the upper limit speech coding rate information 160 to the speech CODEC 130.

The mobile communicator 101 also comprises a speech coding rate controller 134 and a speech coding rate selector 636. They function as encoding rate deciding means for deciding an adequate encoding rate among a first encoding rate selected by the terminal user and inputted via the upper limit speech coding rate selector 150, a second encoding rate outputted by an autocorrection function calculator 632 which computes the encoding rate based on the spectral density of a speech signal inputted from a microphone 602 and a third encoding rate decided by a speech coding rate external control signal 607 inputted to a call processing processor 606 from a base station 642 via an antenna 615 and for selectively switching a Rate 1 encoder 638, a Rate 1/2 encoder 639, a Rate 1/4 encoder 640 and a Rate 1/8 encoder 641 corresponding to the decided encoding rate.

When the speech coding rate controller 134 decides the encoding rate, it outputs the control signal 637 to a speech coding rate selector 636 to control it. Corresponding to the control signal 637, the speech coding rate selector 636 selectively switches the Rate 1 encoder 638, the Rate 1/2 encoder 639, the Rate 1/4 encoder 640 and the Rate 1/8 encoder 641 and controls a path for inputting the transmitted speech signal to either one of the encoders 638 through 641 which is the encoding means for encoding the speech signal with the encoding rate decided by the speech coding rate controller 134.

The present invention is characterized in that it allows the terminal user to select a desired encoding rate and the timing for executing the encoding process with the selected encoding rate to be controlled and allows power consumption to be saved by reducing the operating time of the power amplifier 614 by reducing the encoding rate. Accordingly, it is necessary to provide encoding rate inputting means for inputting the encoding rates and timing control means for controlling the timing for encoding with the inputted encoding rate. The invention comprises the upper limit speech coding rate selector 150 as the encoding rate inputting means and the encoding timing controller 170 as the timing control means.

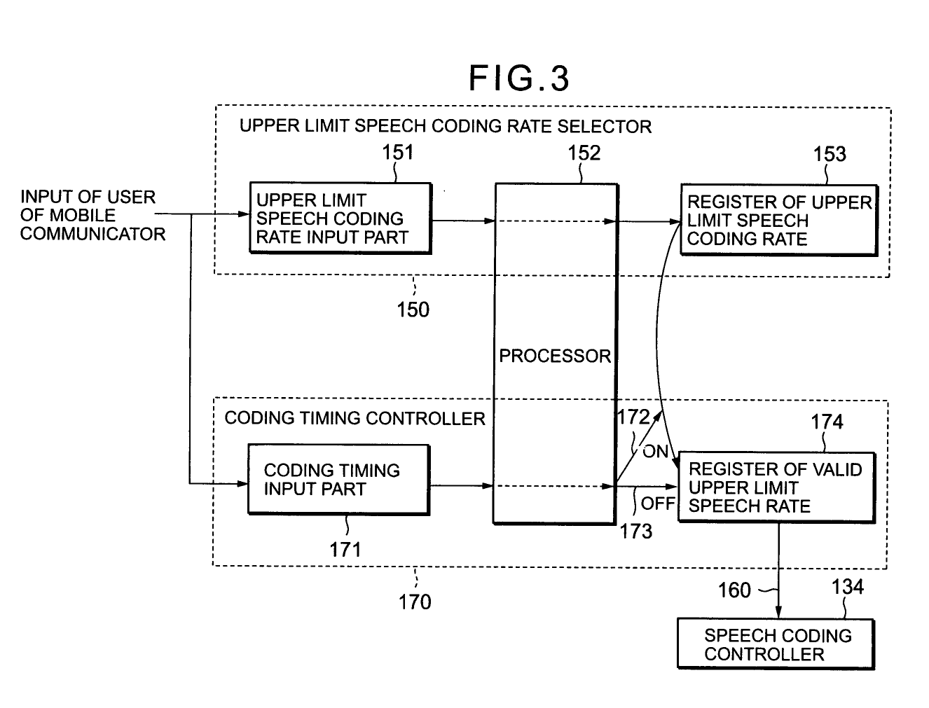

The upper limit speech coding rate selector 150 which functions as the coding rate inputting means allows the terminal user to select and input a desirable encoding rate and the coding timing controller 170 which functions as the timing control means sets the timing for executing the encoding process with the desired encoding rate. The structure and the operation of the upper limit speech coding rate selector 150 and the coding timing controller 170 will be explained with reference to FIG. 3. FIG. 3 is a block diagram of the upper limit speech coding rate selector 150 and the coding timing controller 170 shown in FIG. 1.

The upper limit speech coding rate selector 150 is composed of an upper limit speech coding rate input part 151 and upper limit speech coding rate register 153. The upper limit speech coding rate input part 151 is the coding rate inputting means for inputting the encoding rate selected by the terminal user and plays a role of a so-called interface. The upper limit speech coding rate register 153 stores the encoding rate inputted by the terminal user as the upper limit coding rate.

The coding timing controller 170 is composed of a coding timing input part 171 and a valid upper limit speech coding rate register 174. The coding timing input part 171 is the timing control means for controlling the timing for encoding a speech signal by using the encoding rate selected by the terminal user and outputs a timing control signal to a processor 152 when it detects the input from the terminal user. The processor 152 outputs a set ON signal 172 when it detects an input of the timing control signal and a set OFF signal 173 when there is no input of the timing control signal. The valid upper limit speech coding rate register 174 stores the upper limit coding rate.

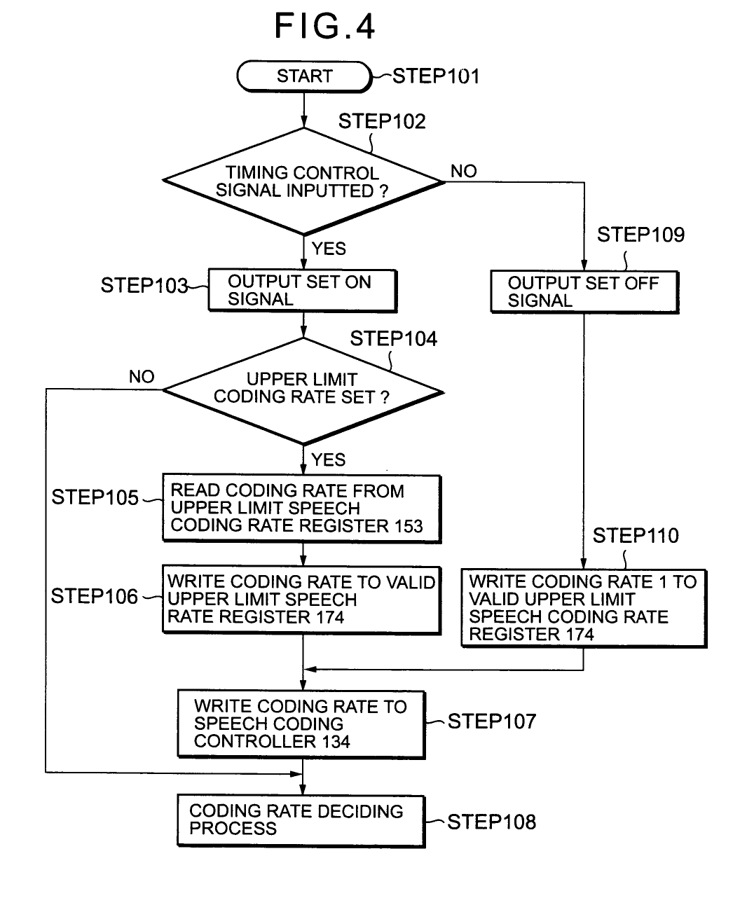

FIG. 4 is a flowchart for explaining the timing controlling process executed by the coding timing controller 170. The timing controlling process of the coding timing controller 170 will be explained below with reference to FIG. 4. When the terminal user inputs a timing control signal (Step 102), the processor 152 which had detected the timing control signal outputs an upper limit coding rate setting command 172 (Step 103). Then, it is confirmed whether the upper limit coding rate has been selected by the terminal user (Step 104). When it has been registered, the encoding rate stored in the upper limit speech coding rate register 153 is transferred and written to the valid upper limit speech coding rate register 174 via the path 154 (Steps 105 and 106). The encoding rate written to the valid upper limit speech coding rate register 174 is written to the speech coding rate controller 134 (Step 107) to decide the encoding rate (Step 108). It is noted that the upper limit speech coding rate register 153 and the valid upper limit speech coding rate register 174 may be allocated as certain addresses in a memory space or as a register.

The speech coding rate controller 134 is connected with the valid upper limit speech coding rate register 174 and controls the transmitting coding rate by making reference to the valid upper limit speech coding rate register 174 (step 108). Meanwhile, when the processor 152 outputs a set OFF signal (path of Rate 1 information) 173 (Step 109), an encoding rate 1 is written to the valid upper limit speech coding rate register 174 (Step 110). That is, when the set OFF signal 173 is outputted, the speech coding rate controller 134 decides the encoding rate by using the conventional coding rate selecting method.

It is noted that the upper limit speech coding rate input part 151 and the coding timing input part 171 may be provided in any device utilized in these days as an input device for inputting data via a keyboard, a touch input, voice input and a serial cable. For instance, it is conceivable to realize the coding timing input part 171 as the timing control means by a push switch. That is, the controllability of the coding timing input part 171 may be simplified by transmitting the timing control signal to the processor 152 at the edge when the push switch is pressed and stopping to transmit the timing control signal at the edge when the push switch is released.

As a concrete use mode, the operating time of the power amplifier 614 may be shortened, thus saving the power consumption, by keeping to press the push switch when the terminal user is listening a speech of the party on the other side of the phone via a telephone network because the encoding process may be carried out by using the selected encoding rate. When the push switch is released when the user talks, the mode is switched to the conventional encoding rate selecting mode and the encoding process is carried with the high encoding rate, so that it becomes possible to communicate with the transmission speech quality in mind.

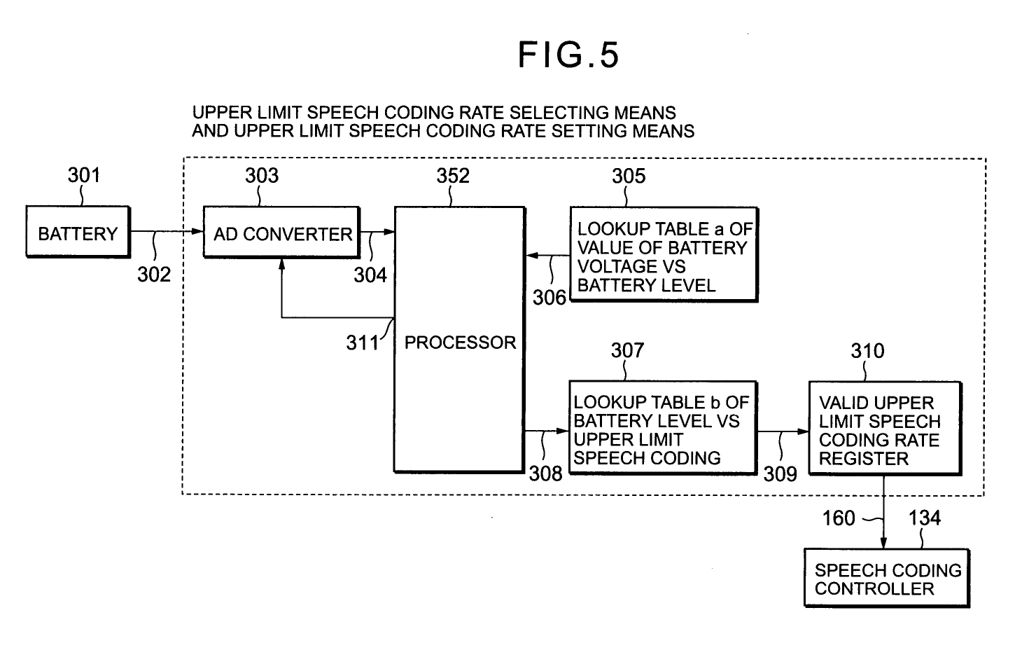

While the case when the terminal user selects the encoding rate and controls the timing of the encoding process by his will has been explained with reference to FIGS. 1, 2, 3 and 4, the arrangement of executing the selection of the encoding rate and the control of the timing of the encoding process corresponding to the residual power level of a battery will be explained with reference to FIG. 5.

FIG. 5 is a block diagram showing the structure of battery monitoring means for monitoring the residual power of the battery and for selecting the upper limit coding rate based on the level of the battery. The battery monitoring means is mounted in a part corresponding to the upper limit speech coding rate selector 150 shown in FIG. 1. In FIG. 5, the reference numeral (301) denotes a battery which is the driving power source of the mobile communicator, (302) a signal indicating an analog voltage value of the battery, (303) an AD converter for converting the analog value of battery voltage 302 into a digital value of voltage, (304) a signal indicating the digital value of voltage, (305) a look-up table a for storing the information on the battery level corresponding to the digital value of battery voltage 304 and (306) a signal transmitting the information on the battery level a corresponding to the digital value of battery voltage 304.

The reference numeral (307) denotes a lookup table b for storing information on the upper limit coding rate corresponding to the information on the battery level a, (308) a signal indicating information b on battery residual amount inputted to the lookup table b 307, (309) a signal indicting information on the upper limit coding rate corresponding to the battery level information b 308, (310) a valid upper limit coding rate storage section for storing the upper coding information a 309, (311) an AD conversion executing command for commanding the AD converter 303 to execute AD conversion and (352) an arithmetic processor having a function for arithmetically processing a digital signal.

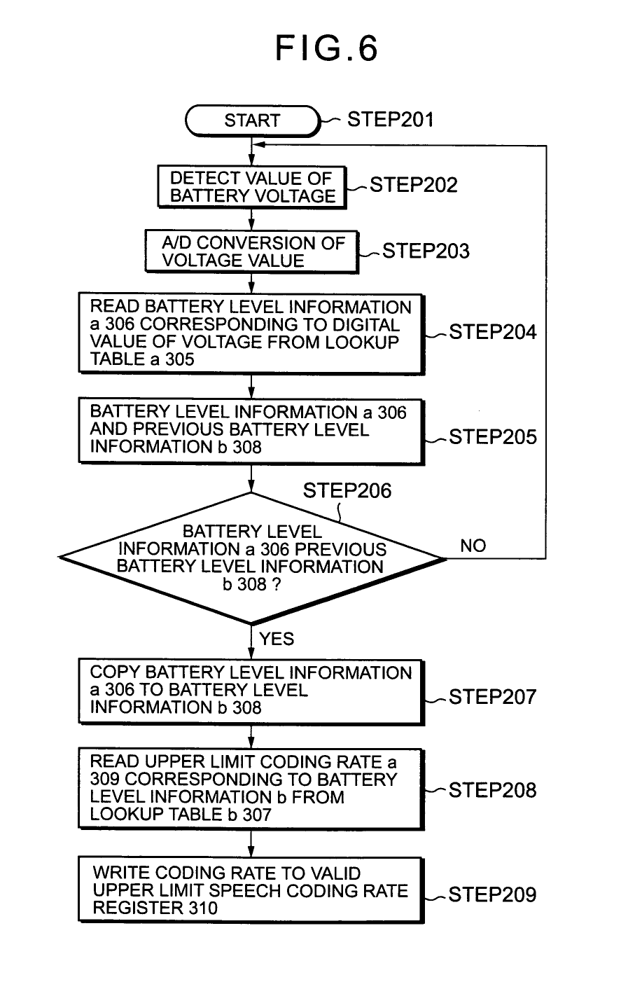

FIG. 6 is a flowchart for explaining the coding rate selecting process based on a residual level of the battery. The coding rate selecting process based on the battery residual level will be explained below with reference to FIG. 6. When the value of battery voltage is detected (Step 202) and the AD conversion start command 311 for converting the value of the detected voltage is issued to the AD converter 303 by the processor 352, the AD converter 303 converts the analog value of battery voltage 302 into the digital value of battery voltage 304 (Step 203). The processor 352 issues the AD conversion start command 311 periodically. Next, the processor 352 obtains the battery level information a 306 corresponding to the digital value of battery voltage 304 while making reference to the lookup table a 305 (Step 204). The lookup table a 305 stores battery voltage and speech operating time when the battery is operated from the battery is fully charged till when it is completely discharged. The battery residual level is decided by equally dividing the speech time from the start of speech till when the speech is disconnected as the battery is completely discharged.

When there is a difference between the detected battery residual level and the battery level information a (Step 206), the processor 352 copies the battery level information a to the battery level information b (Step 207) and transmits the battery level information b to the lookup table b 307. The lookup table b 307 writes the upper coding information a 309 corresponding to the battery level information b 308 to the valid upper limit speech coding rate register 310 (Steps 208 and 209). The speech coding rate controller 134 reads the information stored in the valid upper limit speech coding rate register 310 as the upper limit speech coding rate information 160 in deciding the coding rate.

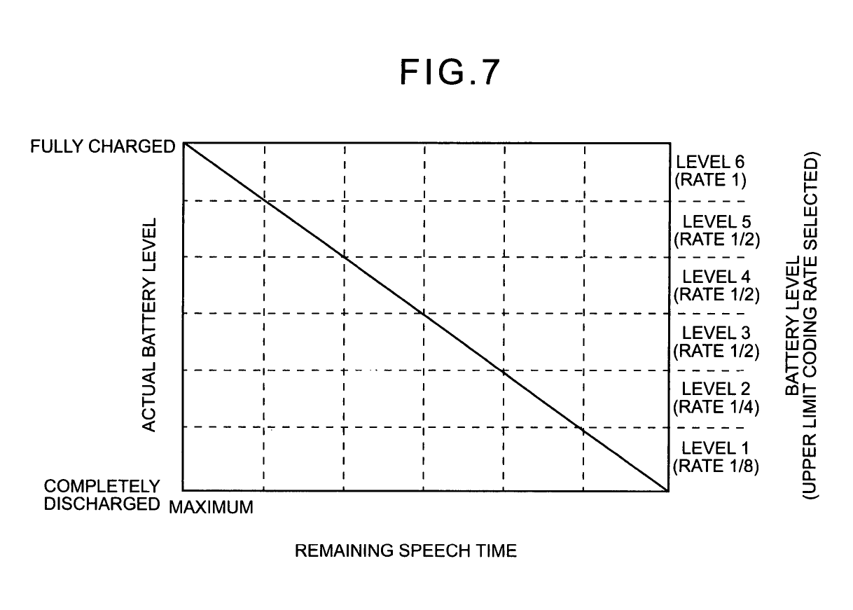

The lookup table b 307 for storing the upper limit coding rate value corresponding to the battery level information will be explained with reference to FIG. 7. In FIG. 7, the battery level is divided into six stages, wherein the residual level 6 indicates the state in which the battery level is the largest and the residual level 1 indicates the state in which the battery level is the least. The figure also shows that Rate 1 is selected in the residual level 6. It means that during this period, the encoding rate is decided by the conventional speech coding rate deciding method. It also shows that Rate 1/2 is selected in the residual levels 3, 4 and 5.

Rate 1/4 is selected in the residual level 2 and Rate 1/8 is selected in the residual level 1. However, the speech encoded with Rate 1/8 is not clear and does not function of speech, so that the terminal user utilizes the terminal unit as a receiver for listening voice of the person on the other side of the line. The power consumption is reduced and each period of residual level is remarkably prolonged by deciding the encoding rate corresponding to the battery level. Accordingly, it becomes possible to prolong the speech time even in the circumstance in which the battery residual level is low. More concretely, it has an effect of prolonging the speech time by encoding by lowering the transmission speech quality in a circumstance in which the user wants to continue the speech receiving operation even though the battery level is almost exhausted or in an environment in which the voice of the user of the mobile communicator enters in the same degree of intensity with acoustic background noise.

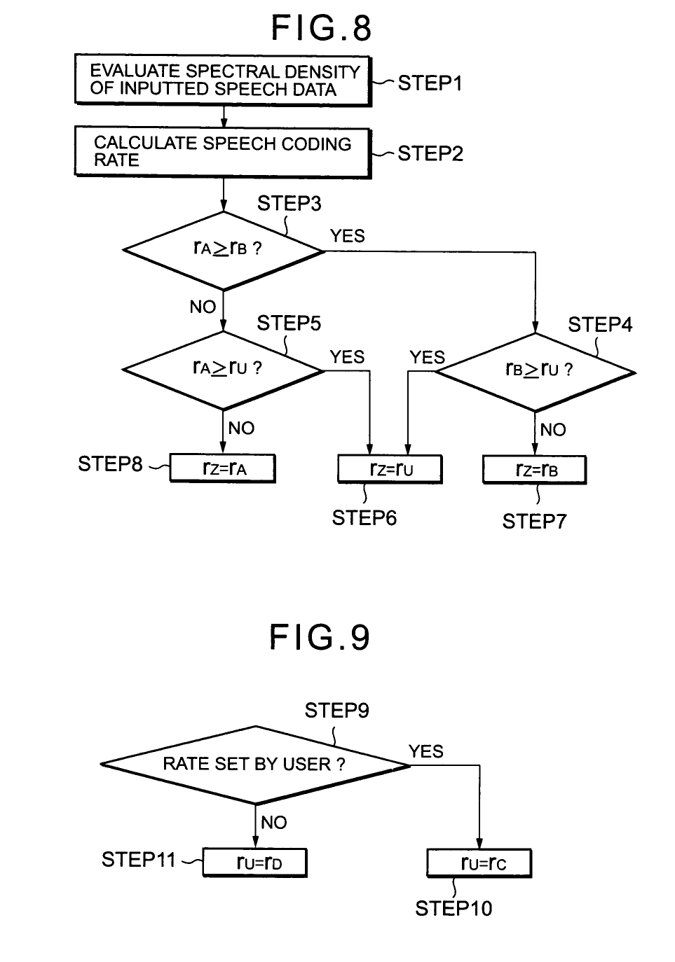

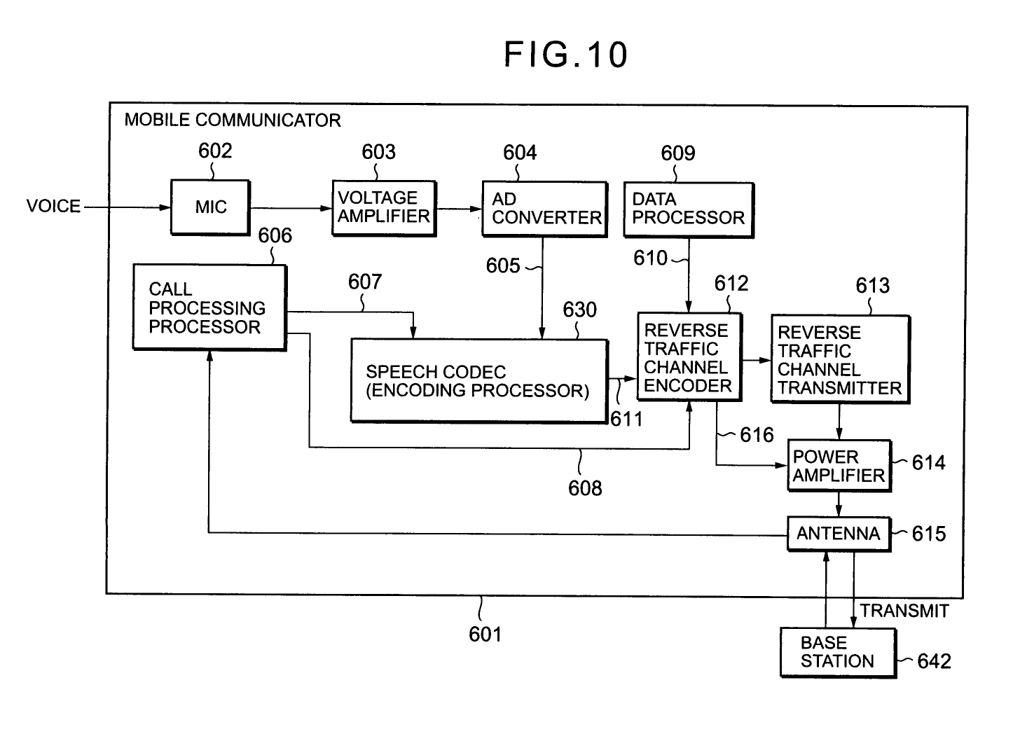

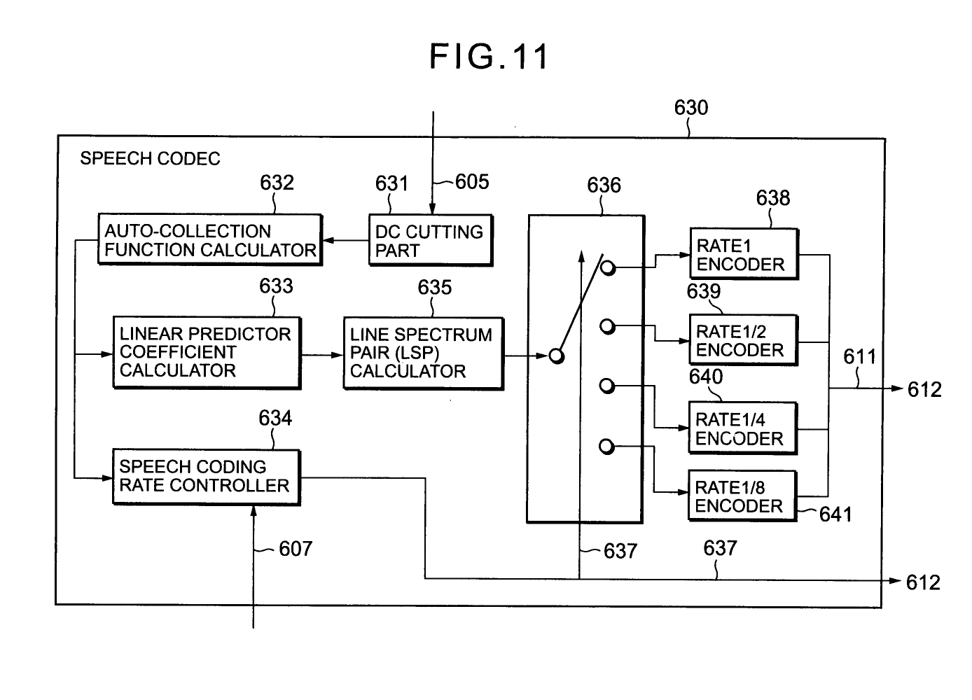

The mechanism which allows the terminal user to select the encoding rate and to control the timing of the encoding process by his will and the mechanism of executing them corresponding to the battery level have been explained. Then, the process for deciding the encoding rate in the speech coding rate controller 134 will be explained with reference to FIGS. 8 and 9. The encoding rate selected by the terminal user and inputted via the upper limit speech coding rate selector 150 will be called as a first encoding rate, the encoding rate computed based on the spectral density of the speech signal inputted from the microphone 602 as a second encoding rate, the encoding rate inputted from the base station 642 as a third encoding rate and the encoding rate decided from the voltage of the battery as a fourth encoding rate for convenience.

While the speech coding rate controller 134 implements a process for deciding an encoding rate among the first, second, third and fourth encoding rates, the question is to which encoding rate the preference should be given among those four encoding rates.

The preference is given to the third encoding rate inputted from the base station 642 among the four encoding rates inputted to the speech coding rate controller 134 because it is related with a system capacity of the communication network. That is, when the value of the third encoding rate transmitted from the base station is the lowest among the first through fourth encoding rates, the transmission signal is encoded by using the third encoding rate without choice. However, when the first, second or fourth encoding rate is lower than that third encoding rate, it is necessary to clear the preference among the encoding rates how to give the preference to which encoding rate and to decide as the transmission encoding rate because either encoding rate may be used basically.

FIG. 8 is a flowchart for explaining the process for deciding the encoding rate (hereinafter referred to as r_{Z}) which is outputted from the speech coding rate controller 134 to the speech coding rate selector 636. The spectral density of the speech signal inputted from the microphone 602 is evaluated in Step 1 and a speech coding rate (hereinafter referred to as r_{A}) is calculated based on the result of Step 1 in Step 2. Step 2 is executed in the autocorrection function calculator 632 shown in FIG. 2.

The speech coding rate r_{A} computed in Step 2 is compared with a speech coding rate (hereinafter referred to as r_{B}) transmitted from the base station in Step 3. When it is judged that r_{A}≧r_{B} (YES) in Step 3, the speech coding rate r_{B} is compared with a speech coding rate (referred to as r_{U}) in Step 4. It is noted that although r_{U} is the speech coding rate set on the side of the mobile communicator, it contains no encoding rate r_{A} computed from the spectral density of the inputted speech signal.

r_{U} contains an encoding rate (called r_{C}) selected by the terminal user and inputted via the upper limit speech coding rate selector 150 as well as an encoding rate (called r_{D}) whose upper limit is limited based on the battery level. The selection of r_{C} and r_{D} will be explained later with reference to FIG. 8. When it is judged that r_{B}≧r_{U} (YES) in Step 4, the process advances to Step 6 to decide r_{U} as r_{Z}. When it is judged that r_{U} is greater than r_{B} (NO) in Step 4, the process advances to Step 7 to decide r_{B} as r_{Z}.

Meanwhile, when it is judged that r_{B} is greater than r_{A} (NO) in Step 3, the process advances to Step 5 to compare r_{A} with r_{U}. When it is satisfied that r_{A}≧r_{U} (YES) in Step 5, the process advances to Step 6 to decide r_{U} as r_{Z}. When it is judged that r_{U} is greater than r_{A} (NO) in Step 5, the process advances to Step 8 to decide r_{A} as r_{Z}.

FIG. 9 is a flowchart for explaining the process for deciding the encoding rate r_{U} executed based on the result of the process for deciding the encoding rate r_{Z} explained with reference to FIG. 8. It is judged whether or not the upper limit encoding rate has been set by the terminal user in Step 9. When the terminal user has been inputted the upper limit encoding rate via the upper limit speech coding rate selector 150 shown in FIGS. 1 and 2, it is judged to be YES and the process advances to Step 10 to decide the encoding rate r_{C} selected by the terminal user as r_{U}. Meanwhile, when the terminal user has set no upper limit encoding rate, it is judged to be NO and the process advances to Step 11 to decide the encoding rate r_{D} whose upper limit is limited based on the battery level as r_{U}.

As described above, the invention allows the selection of the encoding rate, which has been dependent on the spectral density of inputted speech data and on the control from the base station, and the timing of the process for encoding signals by using the selected encoding rate to be controlled in accordance to the intention of the terminal user or to the battery level, so that it has become possible to realize the power-saving of the mobile communicator by shortening the operating time of the power amplifier by suppressing the high encoding rate from being selected.

That is, although the speech coding rate has been decided depending on the inputted sound energy and on the control from the base station in the past, the inventive mobile communicator allows the terminal user to select any speech coding rate according to his will. It also allows the upper limit value of the encoding rate to be set autonomously and thereby, it has become possible to switch the encoding rates by judging the trade-off of the transmitting sound quality and the speech operating time of the mobile communicator.

Further, although the speech coding rate has been lowered under the control of the base station in the past, the inventive mobile communicator reduces the speech coding rate depending on the state of the battery of the mobile communicator, so that it has become possible to prolong the operating time by efficiently operating the power amplifier and by saving power.

Still more, although the timing for lowering the speech coding rate has been dependent on the control of the base station in the past, the inventive mobile communicator is provided with the means for switching the encoding rates according to will of the terminal user, so that it has become possible to apply the encoding rate desired by the terminal user at arbitrary timing and to prolong the usable time of the mobile communicator. Accordingly, it has become possible for the terminal user to turn ON/OFF the upper limit of the encoding rate briskly corresponding to the importance of the contents of the speech to be transmitted in the environment in which the mobile communicator is used or via a telephone network.

While, the preferred embodiments have been described, variations thereto will occur to those skilled in the art within the scope of the present inventive concepts which are delineated by the following claims.

What is claimed is:

1. A mobile communicator that encodes an inputted speech signal, amplifies the encoded speech signal and transmits the amplified encoded speech signal, comprising:
an encoder that encodes an inputted speech signal at one of a plurality of different speech encoding rates;
a speech encoding rate selector that allows a user of the mobile communicator to select one of said plurality of different encoding rates as an upper limit speech encoding rate; and
a speech encoding rate controller that determines a speech encoding rate used by said encoder to encode said inputted speech signal, wherein the determined speech encoding rate is less than or equal to the upper limit speech encoding rate selected by said user.

2. A mobile communicator as set forth in claim 1, further comprising:
an encoding rate storage section for storing an encoding rate selected by said user; and
an encoding timing controller that controls output of a stored encoding rate from said encoding rate storage section to said speech encoding rate controller in accordance with a timing input of said user.

3. A mobile communicator as set forth in claim 1, further comprising:
a battery level monitor that monitors residual power of a battery power supply of said mobile communicator and outputs a signal corresponding to the monitored residual power;
wherein said speech encoding rate controller determines said speech encoding rate used by said encoder in accordance with residual power of said battery power supply as indicated by said signal outputted by said battery level monitor.

4. A mobile communicator as set forth in claim 3, further comprising:
a battery level storage section that stores speech encoding rates corresponding to various battery residual power levels;
wherein said battery level monitor selects a speech encoding rate from said battery level storage section in accordance with a monitored residual power of said battery power supply and provides said selected speech encoding rate to said speech encoding rate controller.

5. A mobile communicator as set forth in claim 3, wherein said speech encoding rate controller determines said speech encoding rate used by said encoder in accordance with said encoding rate selected by said user, a speech encoding rate selected by said battery level monitor corresponding to said monitored residual power, a speech encoding rate received in a control signal from a mobile communication network, and a speech encoding rate computed from an inputted speech signal.

6. A method for determining a speech encoding rate of a mobile communicator, comprising the steps of:
receiving a selected speech encoding rate as inputted to said mobile communicator by a user of said mobile communicator as an upper limit speech encoding rate; and
determining a speech encoding rate to be used by a process for encoding a speech signal inputted to said mobile communicator such that the determined speech encoding rate is less than or equal to the received selected speech encoding rate.

7. A method as set forth in claim 6, wherein said step of determining further comprises the steps of:
receiving a speech encoding rate corresponding to residual power of a battery power supply of said mobile communicator;
receiving a speech encoding rate from a control signal from a mobile communication network;
receiving a speech encoding rate computed from an inputted speech signal;
comparing said speech encoding rate from said control signal with said speech encoding rate computed from said inputted speech signal and selecting the lower of said speech encoding rates as a first comparison encoding rate;
comparing said user-selected speech encoding rate with said speech encoding rate corresponding to residual power and selecting the lower of said speech encoding rates as a second comparison encoding rate; and
comparing said first comparison encoding rate with said second comparison encoding rate and selecting the lower of said comparison encoding rates as a speech encoding rate for encoding said inputted speech signal.

8. A method as set forth in claim 6 wherein said step of determining further comprises the steps of:
receiving a timing control signal inputted to said mobile communicator by said user; and
using said selected speech encoding rate to determine a speech encoding rate to be used by a process for encoding a speech signal inputted to said mobile communicator only when said timing control signal has been received.

9. A method for determining a speech encoding rate of a mobile communicator, comprising the steps of:
receiving a speech encoding rate corresponding to residual power of a battery power supply of said mobile communicator;
receiving a speech encoding rate from a control signal from a mobile communication network;
receiving a speech encoding rate computed from an inputted speech signal;
determining whether a selected speech encoding rate has been inputted to said mobile communicator by a user of said mobile communicator as a maximum speech encoding rate;
if a selected speech encoding rate has been inputted by a user, setting the selected inputted encoding rate as a first comparison encoding rate;
if a selected speech encoding rate has not been inputted by a user, setting the speech encoding rate corresponding to residual power as said first comparison encoding rate;
comparing said speech encoding rate from said control signal with said speech encoding rate computed from said inputted speech signal and selecting the lower of said speech encoding rates as a second comparison encoding rate; and
comparing said first comparison encoding rate with said second comparison encoding rate and selecting the lower of said comparison encoding rates as a speech encoding rate for encoding said inputted speech signal.
